(19) United States
(12) Patent Application Publication
(10) Pub. No.: US 2006/0020699 A1
(43) Pub. Date: Jan. 26, 2006

(54) Method and computer program for web site performance monitoring and testing by variable simultaneous angulation

(76) Inventor: John J. D'Esposito, Wayside, NJ (US)

Correspondence Address: ROBERT M. SKOLNIK, 353 Monmouth Road, PO Box 22, West Long Branch, NJ, 07764-0022, US

(21) Appl. No.: 10/898,453

(22) Filed: Jul. 23, 2004

(51) Int. Cl. G06F 15/173

(52) U.S. Cl. 709/224

(57) ABSTRACT

A system for monitoring and measuring web applications by a user monitors a web site from multiple points of presence and alerts the web site operator when problems are detected. The system may be used in both corporate intranets and by web site operators. It provides alert information when a web site is not responding, when outages occur, monitors availability, and provides information as to the cause of the problems. The system operates by probing web applications at a chosen frequency from several locations simultaneously, which is called variable simultaneous angulation.

### CROSS REFERENCE TO RELATED APPLICATIONS

None.

### BACKGROUND OF THE INVENTION

1. Field of the Invention

The present invention relates to monitoring and measurement of web applications from a user's perspective. The invention monitors a web site from multiple points of presence and alerts the web site operator when problems are detected. The invention is used in both corporate intranets and by web site operators. The invention provides alert information when a web site is not responding, when outages occur, monitoring of availability, and provides information as to the cause of the problems. The invention operates by probing web applications at a chosen frequency from several locations simultaneously, called variable simultaneous angulation.

2. Description of the Related Art

Existing products commonly found in the marketplace contain the ability to remotely probe and monitor Internet protocols for availability and response time. There are monitoring services available on the Internet from Mercury Interactive, Alertsite, Internetsteer, Keynote, WebsitePulse, Watchmouse and Gomez. The main problem with these services is that they do not probe and monitor from the remote locations in a simultaneous fashion. Although they probe and monitors from several remote locations, they do not probe from all locations simultaneously.

Another problem with existing products is they do not empower the end user to dynamically specify the number of remote probe locations to be used within the probing event or which specific probe locations to probe from.

Another problem with existing products is they it do not enable the end user to define and configure an error determination threshold (“EDT”). The error determination threshold represents the number of failure incidents reported back by simultaneous probes which exceeds the end user's subjective threshold for a satisfactory result.

The ability to define an EDT means that the end-user decides exactly how many failures within a probing event constitute a true error.

### SUMMARY OF THE INVENTION

The main object of the invention is to simultaneously probe or monitor a TCP/IP networked device, such as a web application, residing on a web server from remote physical geographic locations through out the world. Another object of the invention is to empower the end user with the ability to dynamically configure the EDT.

A still further object of the invention is the simultaneously probing of tcp/ip networked appliances and/or processes which run on them, from variable remote geographic locations to provide availability and response time metrics as well as alerting when problems are discovered.

Another object and advantage of the invention is the provision of a system which is capable of detecting that one particular member of a cluster of devices is having a problem by permitting the user to set the EDT.

A still further object and advantage of the invention is the provision of a system which enables an end user to establish a number which represents the amount of time in seconds whereby a probing event should be marked as an error. If the actual response time of the probing event reaches or exceeds this response time threshold, the event will be marked as an error condition.

The foregoing, as well as further objects and advantages of the invention will become apparent to those skilled in the art from a review of the following detailed description of my invention, reference being made to the accompanying drawings.

### BRIEF DESCRIPTION OF THE DRAWINGS

FIG. 1 is a block diagram of the operations of the invention showing the interconnections of the main probing components;

FIG. 2 is a block diagram of the operations of the invention showing the interconnections of the end-use interface components;

FIGS. 3A-3C show a flow chart of the computer program of the invention; and

FIGS. 4A-4B show a flow chart of the cluster member detection program of the invention.

### DETAILED DESCRIPTION OF THE PREFERRED EMBODIMENT

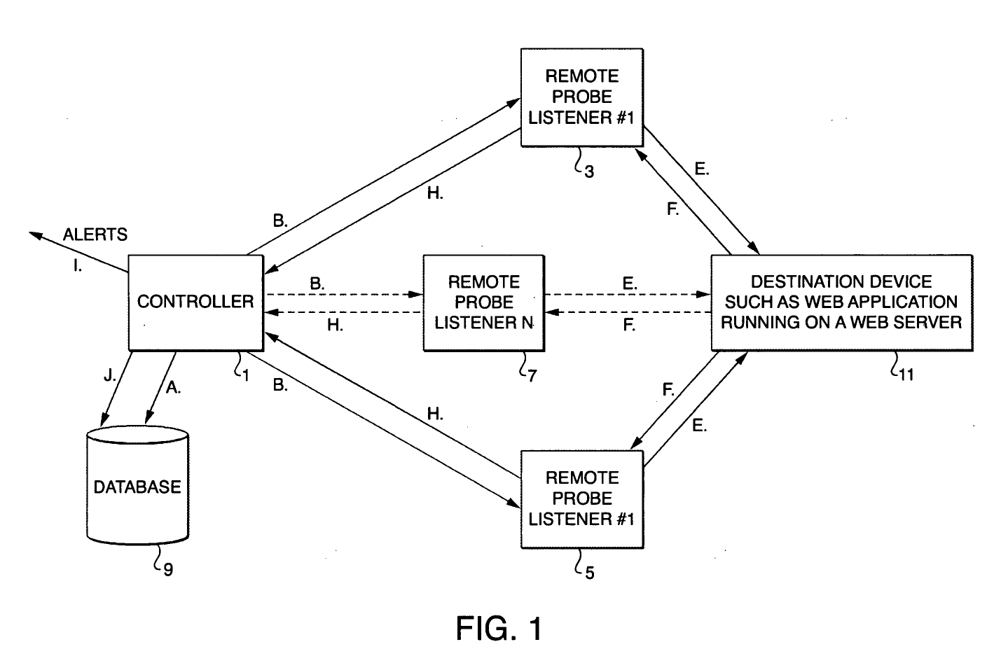

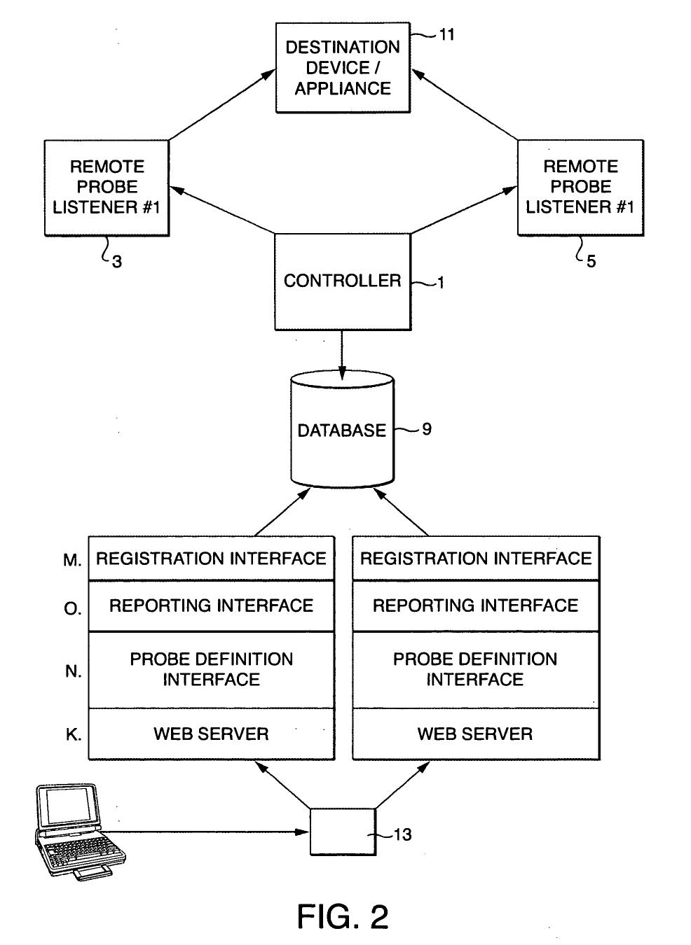

Like reference numerals have been used to designate like parts in FIGS. 1-2.

The main components of the invention are the controller, the remote probe listener, the probe definition, the database, the probe definition interface, reporting interface, the registration interface, and the Remote Probe XML document.

The controller is a multithreaded java based program. The controller has several purposes. Its primary role is to drive all processing by determining which probes are ready to run, construction of simultaneous threaded requests to remote probe listeners which contain the probe definition, receiving responses from the remote probe listeners, applying the error logic and the Error Determination Threshold to the results, updating the database with the results, and constructing and sending alerts.

The Remote Probe Listener is a J2EE based servlet component, which receives requests from the controller. Once a request is received, Remote Probe Listener will probe the remote appliance/process using the protocol and configuration provided within the probe definition.

The Probe Definition is an xml based document which describes all required information relating to the characteristics of the probe, such as which Remote Probe Listeners should be used, the transaction and steps the Remote Probe Listener will invoke, the Error Determination Factor, and alert information.

The database is a storage mechanism used to house several types of data used within the entire process. The database houses probe definitions, probe results, help and other types of records.

The Probe Definition Interface is an http(s) based web application, which provides the end user the ability to create and configure a probe and define its characteristics.

The Probe Reporting Interface is an http(s) based web application, which provides the end user the ability to view individual probe results, and daily and weekly report summaries.

The Registration Interface is an http(s) based web application, which provides the end user the ability register to the service, and establishes a username/password for authentication and entitlement to the system.

The Remote Probe Listener Response document is an xml-based representation of the overall results of the particular remote probe. The document also contains vital response and/or error information received for each step within the overall transaction.

The controller is a multi-threaded java based program. The controller has several purposes. Its primary role is to drive all processing by determining which probes are ready to run, construction simultaneous requests to remote probe listeners contain the probe definition, receiving responses from the remote probe listeners, applying the error logic and the Error Determination Threshold to the results, updating the database with the results, and constructing and sending alerts.

The controller may be written in any software language capable of performing iterative operations, applying basic software development techniques, can parse XML, can perform multithreaded operations, and can read/write to a database.

The remote probe listener is a Java 2 Enterprise Edition (J2EE) compliant java servlet. It runs within the constructs of a Java Servlet Engine. By its nature, the servlet can handle many requests in a scalable fashion.

When activated, the remote probe listener continually waits for requests from the controller. When a request is received, the remote probe listener authenticates and applies entitlement to the request. If the request has been authenticated and entitled, the remote probe listener will begin processing the request. The remote probe listener will obtain the probe definition from the https post request. The remote probe listener will parse the probe definition to obtain the parameters for the setup of probing the remote networked appliance or process as defined in the probe definition.

Based on the nature of the protocol and the parameters contained within the probe definition, the remote probe listener will probe the remote networked appliance/process. The probe definition contains instructions, which make up the transaction. The transaction is a series of iterative steps the remote probe listener will perform as defined within the probe definition.

The remote probe listener uses java socket programming as its basis for performing the protocol communications required by the probe definition. The java.net package of the Java 2 Standard Edition version 1.4.2 is the underlying application programming interface component used to construct protocol requests.

The remote probe listener is designed to maintain persistence and respect the specifications of standard widely used specifications. For instance, when the remote probe listener is asked to perform a step which contains a hyper text transport protocol secure sockets layer connection, the request will be sent according to the world wide web consortium's specification for http found at http://www.w3.org.

Regardless of the protocol being used, the remote probe listener attempts to retrieve the following information from each step or request within a transaction.

(a) Secure Sockets Layer (SSL) Negotiation Time—The amount of time required to perform an SSL handshake between the remote probe listener and the remote networked appliance/process if SSL or encryption is defined to be used.

(b) Connect Time—The amount of time required to perform an TCP/IP protocol connection between the remote probe listener and the remote networked appliance/process. For instance, in the case of the hypertext transport protocol (http), the connect time would represent the duration of time to establish the http connection.

(c) Redirect Time—The amount of time required for a redirection event to occur. For instance, the http protocol has the ability to redirect the requester to a different destination. The redirect time represents the amount of time required for the redirection event to complete.

(d) First Byte Time—The amount of time it took to receive the first byte of data back from the remote networked appliance/process after the connection was established.

(e) Content Download Time—The amount of time it took to receive all of the content after the first byte was received.

(f) Total Bytes—The total number of bytes transferred from the remote networked appliance/process to the remote probe listener.

Upon successful completion of each step, the remote probe listener will calculate and temporarily store, the ssl negotiation time, connect time, redirect time, first byte time, content download time, and the total bytes received.

As the remote probe listener receives from each step, it will apply logic to determine if an error has occurred. If an error occurs, the remote probe receive will stop processing remaining steps and proceed to compile the results for responding back to the controller.

The remote probe listener will validate whether or not one of the following error types occurred:

Tcp/ip error—an error relating to the underlying networks communication such as a domain name service error, remote host unreachable error, remote host not listening error.

Protocol Based Error—an error as defined within the underlying protocol being used. For instance, if https is the protocol in use, a protocol error could be represented by an http 404 error—object not found, an http 401 error—unauthenticated exception, an http 500 error—internal error exception

Response Time Threshold Error—The probe definition contains a response time threshold, which was originally set by the probe owner. The response time threshold represents a fixed amount of time for which the step duration must respond within. If the response time threshold is exceeded, the remote probe listener will consider this particular probe to be in an error state.

Content Change Validation—Upon successful receipt of each step the remote probe listener will calculate the amount of bytes returned by the remote networked appliance/process. The remote probe listener compares the amount of bytes received from this newly run step, with that of the most recently run result. If the amount of bytes between the two is different, the step is marked for a content change validation warning.

Positive Parse Error Checking—The probe definition contains a list of keywords configured by the end user which should set the state of the step in an error condition if the “word” is found within the text of the response. Upon successful receipt of the response from the remote appliance/process the positive parse error check will be performed by the remote probe listener.

Negative Parse Error Checking—The probe definition contains a list of keywords configured by the end user which should set the state of the step in an error condition if any of the keywords is NOT found within the text of the response. Upon successful receipt of the response from the remote appliance/process, the negative parse error check will be performed by the remote probe listener.

Then, structure the results and prepare for response back to the controller. Regardless if an error has been determined within the steps of the transaction or if the transaction was successful, the remote probe listener will prepare the results and respond back to the controller's thread, which has been waiting for the overall results.

The remote probe listener will formulate the results to be responded back to the controller in the form of an xml document, known as the remote probe listener response document.

Probe Definition

The Probe Definition is an Extensible Markup Language XML representation of a probe. The Probe Definition contains all of the required attributes to uniquely define how a probe should be run, what remote probe listeners it should be run against, how errors should be handled, how notifications (alerts) should be sent.

The Probe Definition XML document contains the following attributes:
Account status;
Whether the probe follows redirects;
Frequency the probe should run;
Whether or not alerts should be sent;
If alerts should be sent, who they should be sent to;
If alerts should be sent, how they should be sent;
Error determination factor.
Time zone offset—Offset in positive/negative integer format representing amount of hours the probe owner's time zone is greater or less than Greenwich Mean Time;
Remote Probe Listener Names;
Remote Probe Listener Urls;
Remote Probe Listener authentication credentials.
Transaction configuration attributes
Steps within the transaction
URL to be used for the step
Authentication Credentials to be used for the step
Data fields to be sent with the step
Maintenance Window range—a range between two dates the probe should not run because the remote appliance/process is perceived to be voluntarily deactivated for maintenance purposes;
Maintenance Window repeating interval—whether the maintenance window repeats on a weekly basis.
   Database

The database is the storage mechanism where probe definitions, probe results, key system configuration records are stored. The database contains tables and views. The controller reads from the database to retrieve probe definition records and writes the results of probes as result records to the database.

Probe Definition Interface

The probe definition interface is a standard web server based application. The interface enables end users to logon to the system through a web browser and create a probe definition document for each probe they would like to configure. The probe definition interface is built on Lotus Domino server side web technology. The interface provides robust authentication and entitlement to ensure security and privacy. The interface allows the end user to create, modify and delete probe definitions, which are XML based documents, which contain the unique and required parameters, which describe the characteristics of a probe

The probe definition interface can be written in any standard server side web based technology such as Microsoft Active Server Page, Java 2 Enterprise Edition components, Cold Fusion, etc.

Reporting Interface

The reporting interfaces is a J2EE servlet based web application. The application can run within any compliant J2EE web application server. The implementation could be written in other technologies such as Microsoft Active Server Pages, Cold Fusion, etc. The reporting interface enables the user to view a real time history of probe results in both a graphical and non-graphical manner. To access both non-graphical and graphical data, the end user will use an http(s) based we browser.

Non-Graphical

The non-graphical reporting mechanism does contain some graphical components. However, the user will begin by navigating to predefined index/views in a non-graphical manner.

The index/views represent real time probe result documents. The user will be able to scroll through the views until he/she reaches a probe result document of interest. The user will be able to activate an http(s) url to view the probe result document details. When activated, the details will be provided to the end user in both a graphical and non-graphical format for each remote probe listener used during the probing event.

The probe result document contains a summary section with the following information:
Overall Disposition of the probing event as calculated using the Error Determination Threshold (EDT)
For each remote probe listener used to probe the remote appliance/resource
   Remote Probe Listener Name
   Disposition provided by the Remote Probe Listener
   Time of execution by the remote probe listener
   Total Transaction Time recorded by the remote probe listener
   Total Bytes Received by the remote probe listener

For each step within each transaction of each remote probe listener used, the following data will be provided in both a graphical and non-graphical manner.
Secure Sockets Layer Negotiation Time
Connect Time
Redirect Time
First Byte Time
Content Download Time
Total Bytes received.
   All users can view historical probe results through previously determined index/views designed within the database technology such as;
By Probe Name By Probe Date
By Probe Name By Probe Response Time—descending order
Errors only By Probe Name By Probe Date
All Results By Run Time
By Probe Name—Average Response Time

When a user navigates to one of the views, he or she will ultimately be able to drill down to a particular probe response document of interest.

Graphical

Two graphical reports are provided to demonstrate availability and response time of a probe over the course of time. A 24 hour report—provides graphical analysis of availability and response time over last 24-hour period. A day report—provides graphical analysis of availability and response time over last 7 days.

Remote Probe Response Document

As with the request communication from the controller to the remote probe listeners, the response communication from the remote probe listeners to the controller is in the form of XML traveling over the https protocol. The remote probe listener xml document is an extensible markup language representation of the result as determined by the remote probe listener.

The remote probe listener XML document contains the following attributes:
Remote probe listener location
final disposition determined by the listener
final error type determined by the listener if an error was encountered
final error detail determined by the listener if an error was encountered
The date/time the remote probe listener completed the request
Total Time duration for the entire transaction calculated by the remote probe listener
Total bytes received for the entire transaction calculate by the remote probe listener
   For each step within the transaction:
Secure Sockets Layer Negotiation Time
Connect Time
Redirect Time
First Byte Time
Content Download Time
Total Bytes received.
   Response Time Threshold

In the present invention, the probing event simultaneously probes a web application from three or more remote locations. Each location has a remote probe listener, which receives the request to probe the web application. Upon making the probe request to the web application, each remote probe listener independently determines the state and health of the response. Several tests are applied. The Response Time Threshold test is one type of test that is not offered by related art.

The Response Time Threshold test allows for the probe owner to establish his/her own time in seconds whereby the remote web application must completely respond in order for the request to be deemed successful. The moment the request is made to the remote web application by the remote probe listener, an internal timer is started. If the remote probe listener does not receive a completed response within the response time threshold time, the request is aborted and a response time threshold timeout error is declared. This specific remote probe listener will report back an error.

Error Determination Threshold

Variable Simultaneous angulation is a probing event based act of simultaneously probing a web application/site from three or more distinct remote locations. Each location would have an active remote probe listener, listening for requests from the controller. It is possible that one or more remote probe listeners may report an error condition while others do not. Although one or more remote probe listeners may return an error condition, the owner of the probe may not wish to declare the entire event as a failure. The owner may subjectively consider the event to be in error if two or more remote probe listeners return a response as an error condition.

The present invention enables the user of the probe to establish an error determination threshold (“EDT”). The error determination threshold represents the number of “in error” returned probe listeners the owner bases the entire probing event to marked as an error condition.

The following is an example of the results obtainable by when the EDT is set at one or two.

| | | Remote Probe | Remote Probe | Remote Probe | Error | |
|---|---|---|---|---|---|---|
| | | Listener #1 | Listener #2 | Listener #3 | Determination | Final |
| Probe | Event | (Tokyo, Japan) | (Asbury Park, | (Asbury Park, | Factor set by | Disposition of |
| Name | # | Response | NJ) Response | NJ) Response | Owner of probe | Probing Event |
| Home | 1 | OK | OK | OK | 1 | OK |
| Page | | | | | | |
| | 2 | OK | OK | Error | 1 | Error |
| | 3 | Error | Error | OK | 1 | Error |
| | 4 | Error | Error | Error | 1 | Error |
| | 5 | OK | OK | OK | 2 | OK |
| | 6 | OK | OK | Error | 2 | OK |
| | 7 | Error | Error | OK | 2 | Error |
| | 8 | Error | Error | Error | 2 | Error |

FIG. 1 is a block diagram of the sequence of operations of the invention showing the interconnections of the main probing components. These main components are controller 1, database 9, remote probe listeners 3, 5 and 7 and a destination device 11. The controller 1 constantly polls database 9 to determine the probes to be run. This connection is represented by line A in FIG. 1. Controller 1 also simultaneously communicates to “N” number of remote listeners 3, 5, and 7 represented by line B. “N” number of remote problem listeners=number of angles. The controller 1 also passes the probe definition to “N” remote probe listeners as xml over https (represented by lines B). Each remote probe listener, 3, 5, 7 receives the probe definition, parses probe definition and simultaneously probe destination device 11 (line E). The remote probe listeners (3, 5, 7) obtain responses from the destination device 11 (line F). The listeners (3, 5, 7) analyze the probe results, formulate the probe response document, pass the document as XML, via https to controller 1, (line H). The controller 1 (via line H) obtains results and applies the results to the Error Determination Threshold as set by the user. The controller 1 sends the alerts (line I) based on the alerting parameters in the probe definition.

FIG. 2 is a block diagram of the operations of the invention showing the interconnections of the end-use interface components. Like reference numerals have been used to designate like parts in FIGS. 1-2. These interface components include controller I and the web server K, residing in computer L, the registration interface M, the probe definition interface N, and the reporting interface O, all residing in the web server. A load-balancing device 13 is provided because of the parallel redundancy of the interface components K, M, N, and O.

The web server K provides interface from browser to web applications, i.e. probe definition interface N, reporting interface O, and registration interface M. The web server also provides authentication and entitlement to web applications.

The end user computer L uses standard web browsers to interface independently with each application. The registration interface M requires that each user be registered to the system and establishes credentials to be authenticated and entitlement to use the system. The registration interface M is the web base application, which enables users to register.

The probe definition interface N permits a user, once registered, to define the unique aspects of the probe. The probe definition interface provides a web browser base mechanism for the user to configure probes and set parameters which ultimately make up the probe definition and reside in the probe definition xml document.

The reporting interface O is a browser-based mechanism to provide real-time reporting back to the end user.

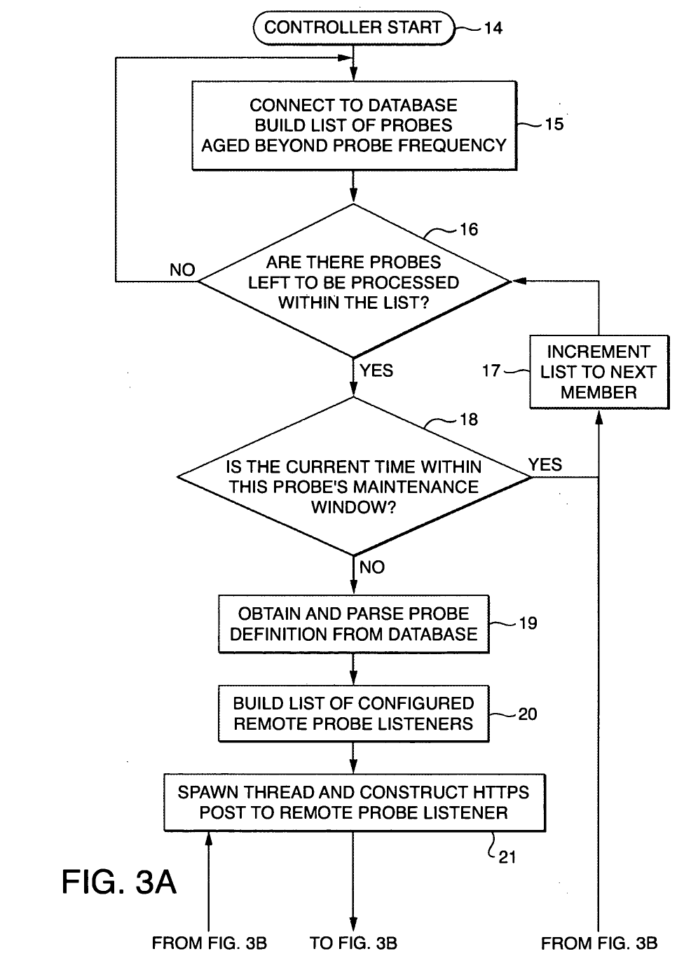

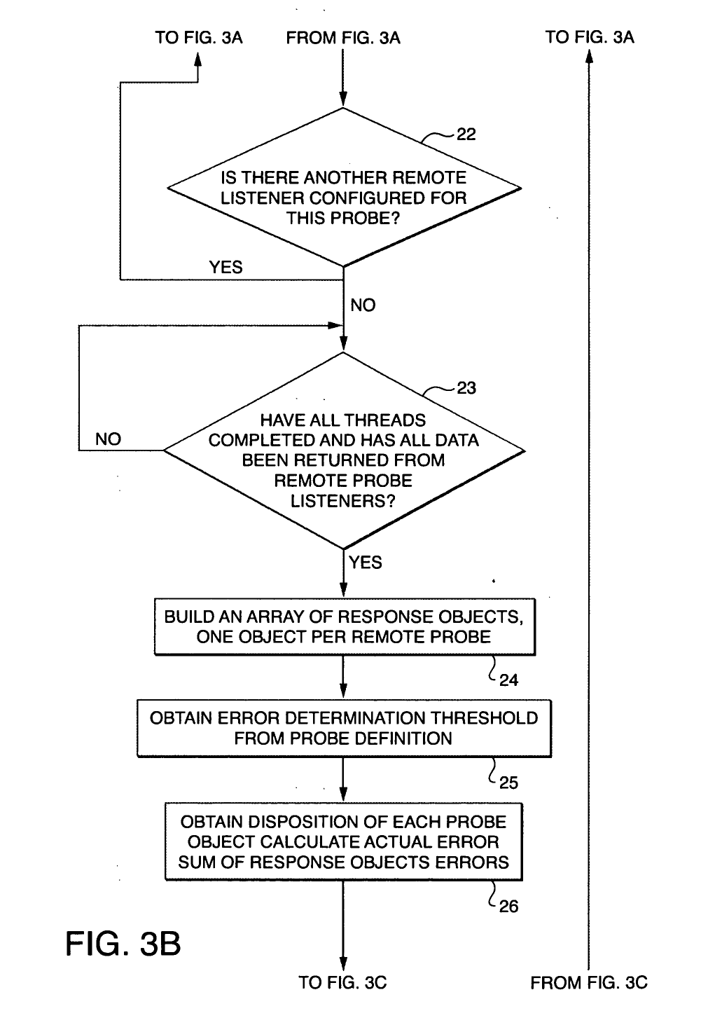

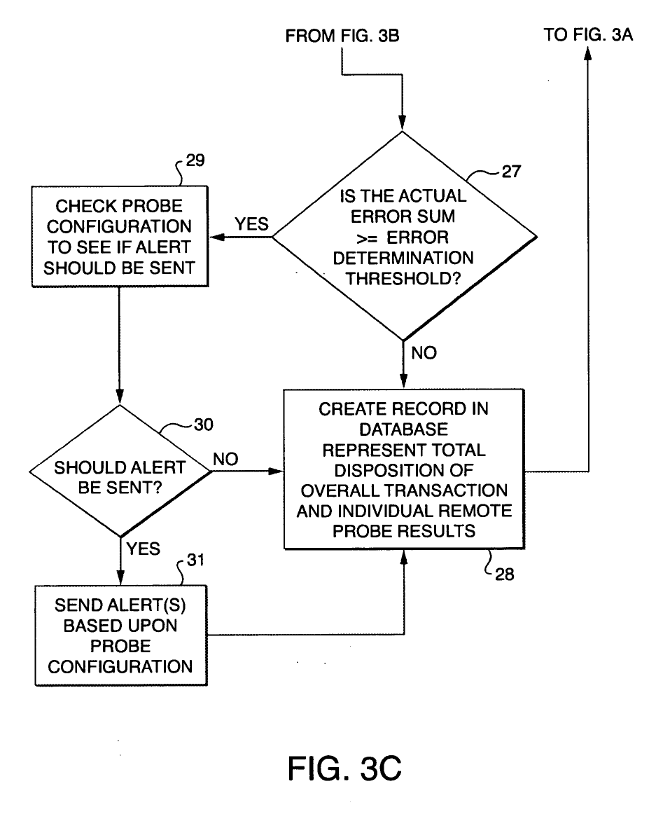

FIGS. 3A-3C is a flow chart of the computer program of this invention. The controller 1 starts (14) and is connected to database 9. The controller instructs (15) the database to build a list of probes aged beyond probe frequency (i.e. that the probe is ready to run). If there are probes left to be processed within the list (16), the current time within the probe's maintenance window is tested (18). If there are no probes left to be processed, the list is complete. If the current time test (18) indicates YES the current time is within the systems maintenance window. The list is incremented to the next member (17). If the current time test (18) indicates NO, the probe definition is obtained from the database and parsed (19). Then (20) a list of configured remote probe listeners is built. Then (21) spawn a single thread and construct https post report to remote probe listener. Then (22), is there another remote probe listener configured for this probe? If YES, return to (21). If NO, (23) have all threads completed and has all data been returned from remote probe listeners? If NO, return to complete the threads (23). If YES, (24), build an array of response objects one object per remote probe. Then, (25), obtain error determination threshold from probe definition. Then (26), obtain disposition of each probe object and calculate actual error sum of response object errors. In (27), the actual error sum is tested to see if it is greater than or equal to the error determination threshold. If YES, (29) check the probe definition to see if alert should be sent. If NO, (28) create a record in the database to represent total disposition of overall transaction and individual remote probe results. If an alert should be sent (30), send alerts (31) based upon probe definition. The transaction records created in (28) are used to increment the list to the next member (17).

Each server contains identical hardware:
1—ASUS Mother Board SIS661FAX
   1—2.66 Gigahertz Intel CPU
   2—80 Gigabyte ATA100 7200 RPM IDE Hard Drive
   2—512 MB DDR Random Access Memory
      Cluster Member Problem Detection

In the method of the present invention, the probing event simultaneously probes a web application from three or more remote locations. Each location has a remote probe listener, which receives the request to probe the web application. Upon making the probe request to the web application, each remote probe listener independently determines the state and health of the request.

The probing event is marked a success or failure depending on the application of the Error Determination Factor on number of failures returned by the remote probe listeners. As previously mentioned, the Error Determination Factor is used to give the probe owner subjective control over handling errors and false alarms. It is important to note the probability exists to have one or more remote probe listener return a failure, but have the probing event marked a success.

Large scale web server systems typically are deployed in a clustered configuration. A cluster is a logical representation of multiple servers whereby each server provides the same functionality. Multiple servers are used in the configuration to provide scalability and high availability. Web requests from browsers are normally distributed evenly across all members of the cluster through the use of load balancing devices.

Monitoring each individual member of the cluster is cost prohibited. Most corporations choose to obtain monitoring through cluster host name. When one or more of the members of a cluster experiences a problem, end users will be affected. Since other members of the cluster remain healthy, a condition is formed whereby intermittent problems are encountered. Prior art technologies and even human user testing often can not detect the condition when one or more members of a cluster are experiencing problems. Although, they may detect a problem because they randomly encountered the problematic member of the cluster, subsequent tests often yield a success, which is deemed as a recovery.

The present invention solves the cluster member failure detection problem by using a combination of Variable Simultaneous Angulation, Error Determination Factor and the use of exponential moving averages to trend success rates to determine the potential existence of a cluster member problem.

The probing event below consists of five simultaneous probes through remote probe listeners located in London, Tokyo, Boulder, Sidney, and Asbury Park. All remote probe listeners reported a success except for Asbury Park, which encountered a failure. With an Error Determination Factor of two, the probing event was marked a Success, since less than two remote probe listeners reported failures. The failure could have been attributed to a false alarm, such as temporary networking problem between the Asbury Park remote probe listener and the destination web server. However, the failure could actually represent a condition whereby one or more of the members of the cluster are experiencing a problem.

In the example set forth in the following table, the Average Success Rate of the probing event is 0.8 or 80%; a Success, S, has a value of 1; and a Failure, F, has a value of 0.

| | | | | | | Average |
|---|---|---|---|---|---|---|
| | | | | | | Success |
| Event # | London | Tokyo | Boulder | Sidney | Asbury | Rate |
| 1 | S | S | S | S | F | 0.8 |

The moving average is a tool that can be used to technically analyze a series of data over a specified period. When a new period of data is created, the oldest period is subtracted or removed, keeping the specified period consistent. All moving averages are lagging indicators. However, moving averages can be useful in spotting trends, which is the goal of Cluster Member Problem Detection.

An exponential moving average (EMA) is a type of moving average that is used to reduce lag by applying more weight to recent data points relative to older data points. The weighting applied to the most recent price depends on the specified period of the moving average. The shorter the EMA's period, the more weight that will be applied to the most recent data point. For example: a 10-period exponential moving average weighs the most recent data point 18.18% while a 20-period EMA weighs the most recent data point 9.52%. The exponential moving average puts more weight on recent data.

Exponential Moving Average Calculation

Exponential Moving Averages can be specified in two ways—as a percent-based EMA or as a period-based EMA. A percent-based EMA has a percentage as it's single parameter while a period-based EMA has a parameter that represents the duration of the EMA.

The formula for an exponential moving average is:
Average Success Rate(ASR)=average success rate as defined above
EMA(current)=((ASR(current)−EMA(prev))×Multiplier)+EMA(prev)
For a percentage-based EMA, “Multiplier” is equal to the EMA's specified percentage. For a period-based EMA, “Multiplier” is equal to 2/(1+N) where N is the specified number of periods.
For example, a 10-period EMA's Multiplier is calculated as follows:

$$\frac{2}{( Time periods + 1 )} = \frac{2}{( 10 + 1 )} = \begin{matrix}.1818 \\ ( 18.18 \% )\end{matrix}$$

This means that a 10-period EMA is equivalent to an 18.18% EMA.

In the present invention, probe owners have the ability to activate or disable cluster member problem detection for the particular probe they are configuring. The present invention employs a method that continually runs to perform EMA calculations. For every completed probe event that has cluster member protection activated, the method applies the EMA calculation based upon the criteria described below. If it is determined that potentially a cluster member problem has been detected, the user will be notified through an alert and when the user logs on to use the invention.

The following example contains twenty-two proving events. The probe as defined by the owner has an error determination threshold of two, which means at least two probes within the probing event must report a failure in order for the entire probing event to be marked a failure. The exponential moving average for the example below is ten periods or ten events.

Event #2 is not used in the exponential moving average calculation since it represents a true probing event failure. Exponential moving average is only calculated when ten successful successive probing events have occurred. In the example below the first EMA calculation occurs at event #12, which is the tenth successive probing event. Probing event #20 represents a critical moment, when the EMA dropped below 90% or 0.90. An EMA below 0.90 signifies a potential problem with a server member of a cluster. If the probe owner has chosen to be notified when this condition occurs, an alert will be sent to the owner. When the user logs into the web site of the invention, the user will be notified of the condition as well.

| | | | | | | Average | Previous | |
|---|---|---|---|---|---|---|---|---|
| Event # | London | Tokyo | Boulder | Sidney | Asbury | Success Rate | EMA of ASR | EMA of ASR |
| 1 | S | S | S | S | F | 0.8 | | |
| 2 | F | S | F | S | S | 0.6 | | |
| 3 | S | S | S | S | S | 1 | | |
| 4 | S | S | S | S | S | 1 | | |
| 5 | S | S | S | S | S | 1 | | |
| 6 | S | S | S | S | S | 1 | | |
| 7 | F | S | S | S | S | 0.8 | | |
| 8 | S | S | S | S | S | 1 | | |
| 9 | S | S | S | S | S | 1 | | |
| 10 | S | S | S | S | S | 1 | | |
| 11 | S | S | S | S | S | 1 | | |
| 12 | S | S | S | S | S | 1 | | 0.98 |
| 13 | S | S | S | S | S | 1 | 0.98 | 0.98363636 |
| 14 | S | F | S | S | S | 0.8 | 0.98363636 | 0.950247964 |
| 15 | S | S | S | S | S | 1 | 0.950247964 | 0.95929378 |
| 16 | S | S | S | F | S | 0.8 | 0.95929378 | 0.930331303 |
| 17 | S | S | F | S | S | 0.8 | 0.930331303 | 0.906634727 |
| 18 | S | S | S | S | S | 1 | 0.906634727 | 0.923610214 |
| 19 | S | S | F | S | S | 0.8 | 0.923610214 | 0.901135652 |
| 20 | S | S | S | F | S | 0.8 | 0.901135652 | 0.88274737 |
| 21 | S | S | S | S | F | 0.8 | 0.88274737 | 0.867702409 |
| 22 | S | S | S | S | S | 1 | 0.867702409 | 0.891756492 |

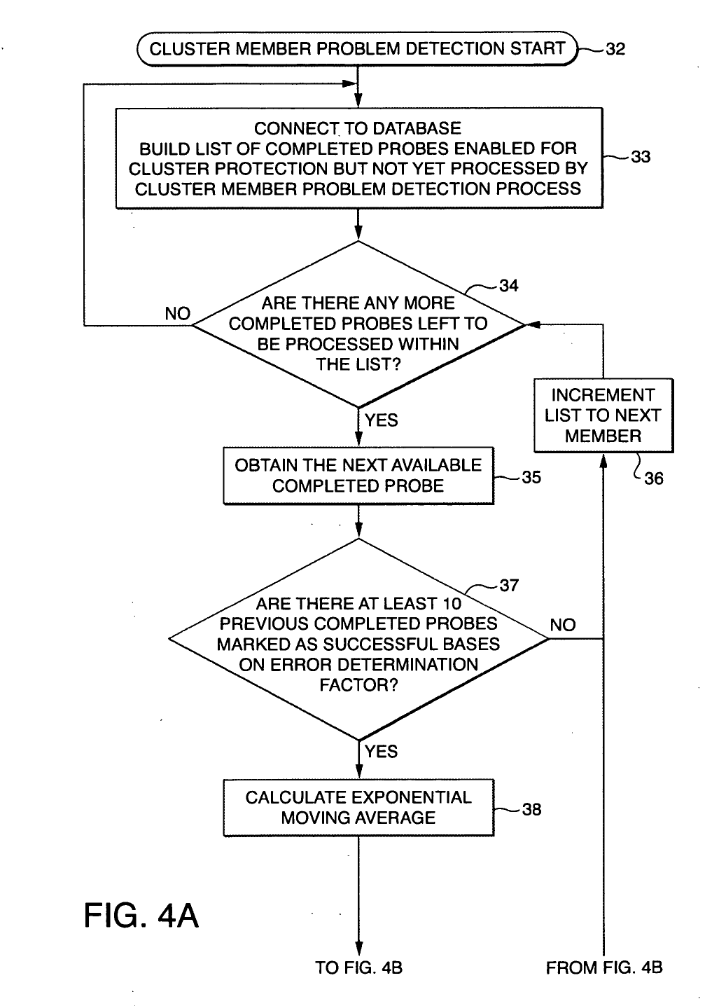

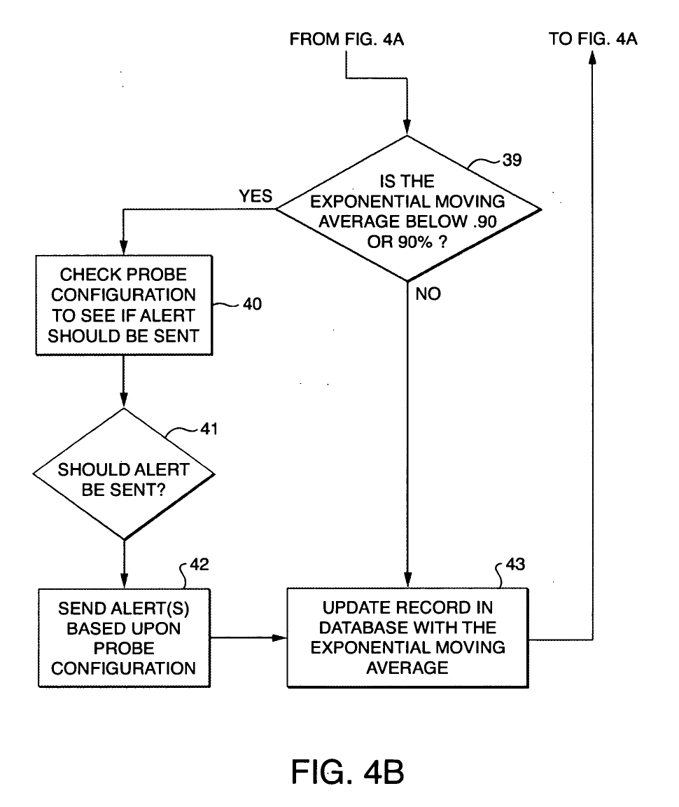

FIGS. 4A-4B is a flow chart of the cluster detection program of the invention. The program is started at 32 by connection to the database to build a list of completed probes enabled for cluster protection but not yet processed by the cluster member problems detection program, 33. Then, the completed probes are tested to see if there are any completed probes left to be processed within the list, 34. If not, the program is complete. If there are completed probes left to be processed, the next available probe is obtained, 35. Then, the program looks for at least ten previously completed probes marked as successful based on the EDT, 37. If not, the list is incremented, 36, to the next member. If there are at least ten probes, the exponential moving average is calculated, 37. If the exponential moving average is below 0.9 or 90%, 39, the probe definition is checked to see of an alert should be set, 40. If not, the record is updated in the database with the exponential moving average, 43. If an alert should be sent, 41, it is set based on probe definition, 42.

Further modifications to the invention may be made without departing from the spirit and scope of the invention; accordingly, what is sought to be protected is set forth in the appended claims.

What is claimed is:

1. A method of testing web applications comprising the steps of: simultaneously addressing a web site from three or more locations to test said web site for (a) secure sockets layer negotiation time, (b) connect time, (c) redirect time, (d) first byte time, (e) content download time, and (f) total bytes; analyzing the results of said tests at each of said three or more locations; and reporting said results.

2. The method of claim 1 further including the step of establishing a threshold representing a minimum number of said three or more locations, which have to report predetermined test results before said test results are deemed to indicate an error condition at said web site.

3. The method of claim 2 further including the step of testing said web site for response time by comparing a predetermined desired response time with the response time obtained from said web site and indicating the results of said comparison.

4. The method of claim 2 further including the step of calculating the exponential moving average of said test results, which do not indicate error conditions at said web site.

5. The method testing a web site for predetermined performance criteria comprising the steps of simultaneously sending the same test signal to said web site from three or more separate locations; and analyzing the test results.

6. The method of claim 5 further including the step of establishing an error determination threshold for said test results for determining how many of said test results must indicate an error condition before said test is deemed a failure of said web site.

7. The method of claim 6 further including calculating the exponential moving average of at least ten separate test results, which do not indicate a failure of said web site.

8. A computer system for testing a web site simultaneously from three or more locations comprising; controller means in the form of a multithreaded Java based program for driving all processing by determining which probes are ready to run; at least three remote probe listening means for receiving requests from said controller; database means connected to said controller for storing data; a web server containing probe definition means for describing testing information for said website; probe definition interface means connected to said probe definition means for enabling a user to construct said probe definition, reporting interface means for displaying and reporting system and testing information, registration interface means for enabling only designated users to access said system, and remote probe XML document means for collecting test results for each probe.

9. The computer system of claim 8 wherein said controller means includes means for determining which probes are ready to run, means for constructing simultaneous threaded requests to remote probe listeners which contain the probe definition, means for receiving responses from remote probe listeners, means for applying error logic and an error determination threshold to the results, means for updating said database with said results, and means for constructing and sending alerts.
